(19) United States
(12) Patent Application Publication
(10) Pub. No.: US 2005/0063608 A1
(43) Pub. Date: Mar. 24, 2005

(54) System and method for creating a panorama image from a plurality of source images

(76) Inventors: Ian Clarke, Toronto (CA); Graham Sellers, Toronto (CA); Zain Adam Yusuf, Mississauga (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/669,828

(22) Filed: Sep. 24, 2003

(51) Int. Cl. G06K 9/36

(52) U.S. Cl. 382/284

(57) ABSTRACT

A system and method of creating a panorama image from a series of source images includes registering adjoining pairs of images in the series based on common features within the adjoining pairs of images. A transform between each adjoining pair of images is estimated using the common features. Each image is projected onto a designated image in the series using the estimated transforms associated with the image and with images between the image in question and the designated image. Overlapping portions of the projected images are blended to form the panorama image.

### FIELD OF THE INVENTION

The present invention relates generally to image processing and more particularly to a system and method for creating a panorama image from a plurality of source images.

### BACKGROUND OF THE INVENTION

Digital cameras are becoming increasingly popular and as a result, a demand for image processing software that allows photographers to edit digital images exists. In many instances, it is difficult or impossible for a photographer to capture a desired entire scene within a digital image and retain the desired quality and zoom. As a result, photographers are often required to take a series of overlapping images of a scene and then stitch the overlapping images together to form a panorama image.

Many techniques for creating a panorama image from a series of overlapping images have been considered. For example, U.S. Pat. No. 5,185,808 to Cok discloses a method for merging images that eliminates overlap-edge artefacts. A modified mask that determines the mixing proportions of overlapping images is used to blend gradually overlapping image at their borders.

U.S. Pat. Nos. 5,649,032, 5,999,662 and 6,393,163 to Burt et al. disclose a system for automatically aligning images to form a mosaic image. Images are first coarsely aligned to neighbouring/adjacent images to yield a plurality of alignment parameters for each image. Coarse alignment is done initially at low resolution and then at subsequently higher resolutions using a Laplacian image pyramid calculated for each image.

U.S. Pat. No. 6,044,181 to Szeliski et al. discloses a focal length estimation method and apparatus for the construction of panoramic mosaic images. A planar perspective transformation is computed between each overlapping pair of images and a focal length of each image in the pair is calculated according to the transformation. Registration errors between images are reduced by deforming the rotational transformation of one of the pair of images incrementally. The images are adjusted for translational motion during registration due to jitter and optical twist by estimating a horizontal and vertical translation. Intensity error between two images is minimized using a least squares calculation. Larger initial displacements are handled by coarse to fine optimization.

U.S. Pat. No. 6,075,905 to Herman et al. discloses a method and apparatus for mosaic image construction in which alignment of images is done simultaneously, rather than by adjacent registration. Images are selected either automatically or manually and alignment is performed using a geometrical transformation that brings the selected images into a common co-ordinate system. Regions of the overlapping aligned images are selected for inclusion in the mosaic by finding appropriate cut lines between neighbouring images and the images are enhanced so that they may be similar to their neighbours. The images are then merged and the resulting mosaic is formatted and output to the user.

U.S. Pat. No. 6,104,840 to Ejiri et al. discloses a method and system for generating a composite image from partially overlapping adjacent images taken along a plurality of axes. Angular relation among overlapping images is determined based upon a common pattern in overlapping portions of the images.

U.S. Pat. No. 6,249,616 to Hashimoto discloses a method of combining digital images based on three-dimensional relationships between source image data sets. Alignment is effected using image intensity cross-correlation and Laplacian pyramid image levels. A computer determines the three-dimensional relationship between image data sets and combines the image data sets into a single output image in accordance with the three-dimensional relationships.

U.S. Pat. Nos. 6,349,153 and 6,385,349 to Teo disclose a method for combining digital images having overlapping regions. The images are aligned and registered with each other. Vertical alignment is further improved by calculating a vertical warping of one of the images with respect to the other in the overlapping region. This results in a two-dimensional vertical distortion map for the warped image that is used to bring the image into alignment with the other image. The distortion spaces left along the warping lines in the overlapping region are then filled in by linear interpolation.

U.S. Pat. No. 6,359,617 to Xiong discloses a method for use in virtual reality environments to create a full 360-degree panorama from multiple overlapping images. The overlapping images are registered using a combination of a gradient-based optimization method and a correlation-based linear search. Parameters of the images are calibrated through global optimization to minimize the overall image discrepancies in overlap regions. The images are then projected onto a panorama and blended using Laplacian pyramid blending with a Gaussian blend mask generated using a grassfire transform to eliminate misalignments.

Although the above-identified references disclose techniques for stitching images together to form a panorama image, improvements are of course desired. It is therefore an object of the present invention to provide a novel system and method for creating a panorama image from a plurality of source images.

### SUMMARY OF THE INVENTION

According to one aspect of the present invention there is provided a method of creating a panorama image from a series of source images comprising the steps of:
registering adjoining pairs of images in said series based on common features within said adjoining pairs of images;
estimating a transform between each adjoining pair of images using said common features;
projecting each image onto a designated image in said series using the estimated transforms associated with said image and with images between said each image and said designated image; and
combining overlapping portions of the projected images to form said panorama image.

Preferably, during the registering, matching corners in the adjoining pairs of images are determined. It is also preferred that after the estimating, the transforms are re-estimated using pixels in the adjoining pairs of image that do not move. During the combining, it is preferred that the overlapping portions of the projected images are frequency blended.

According to another aspect of the present invention there is provided a method of creating a panorama image from a series of source images comprising the steps of:
registering corners in each adjoining pair of images in said series;
using the registered corners to estimate transforms detailing the transformation between each adjoining pair of images;
re-estimating the transforms using non-moving pixels in the adjoining pairs of images;
multiplying series of transforms to project each image onto the center image of said series and error correcting the projections using the registered corners; and
frequency blending the overlapping regions of said projected images to yield said panorama image.

According to yet another aspect of the present invention there is provided a digital image editing tool for creating a panorama image from a series of source images comprising:
means for registering adjoining pairs of images in said series based on common features within said adjoining pairs of images;
means for estimating transforms between adjoining pairs of images using said common features;
means for projecting each image onto a designated image in said series using the estimated transforms associated with said image and with images between said each image and said designated image; and
means for combining overlapping portions of the projected images to form said panorama image.

According to still yet another aspect of the present invention there is provided a computer readable medium embodying a computer program for creating a panorama image from a series of source images, said computer program including:
computer program code for registering adjoining pairs of images in said series based on common features within said adjoining pairs of images;
computer program code for estimating a transform between each adjoining pair of images using said common features;
computer program code for projecting each image onto a designated image in said series using the estimated transforms associated with said image and with images between said each image and said designated image; and
computer program code for combining overlapping portions of the projected images to form said panorama image.

According to still yet another aspect of the present invention there is provided a computer readable medium embodying a computer program for creating a panorama image from a series of source images, said computer program including:
computer program code for registering corners in each adjoining pair of images in said series;
computer program code for using the registered corners to estimate transforms detailing the transformation between each adjoining pair of images;
computer program code for re-estimating the transforms using nonmoving pixels in the adjoining pairs of images;
computer program code for multiplying series of transforms to project each image onto the center image of said series and error correcting the projections using the registered corners; and
computer program code for frequency blending the overlapping regions of said projected images to yield said panorama image.

The present invention provides advantages in that multiple overlapping digital images are stitched together to form a seamless panorama image by automatically calculating a transformation relating each image to a designated image, projecting each image onto a common two-dimensional plane and blending overlapping portions of the images in a seamless fashion. Furthermore, the present invention provides advantages in that the transformations are calculated in a fast and efficient manner that yields a robust set of registration parameters.

### BRIEF DESCRIPTION OF THE DRAWINGS

An embodiment of the present invention will now be described more fully with reference to the accompanying drawings in which:

FIG. 1 is a flowchart showing the steps performed during a panorama image creation process in accordance with the present invention;

FIG. 2 is a flowchart showing the steps performed by the panorama image creation process of FIG. 1 during image registration and projection;

FIG. 3 is a flowchart showing the steps performed by the panorama image creation process of FIG. 1 during image blending;

FIG. 4 is a schematic diagram showing frequency blending of combined images forming the panorama image; and

FIG. 5 is a screen shot showing the graphical user interface of a digital image editing tool in accordance with the present invention.

### DETAILED DESCRIPTION OF THE PREFERRED EMBODIMENT

The present invention relates generally to a system and method of stitching a series of multiple overlapping source images together to create a single seamless panorama image. During the method, a series of related and overlapping source images are selected and ordered from left-to-right or right-to-left by a user. Initial registration between adjoining pairs of images is carried out using a feature-based registration approach and a transform for each image is estimated. After initial transform estimation, the images of each pair are analyzed for motion and the transform for each image is re-estimated using only image pixels in each image pair that do not move. The re-estimated transforms are then used to project each image onto a designated image in the series. The overlapping portions of the projected images are then combined and blended to form a collage or panorama image and the panorama image is displayed to the user.

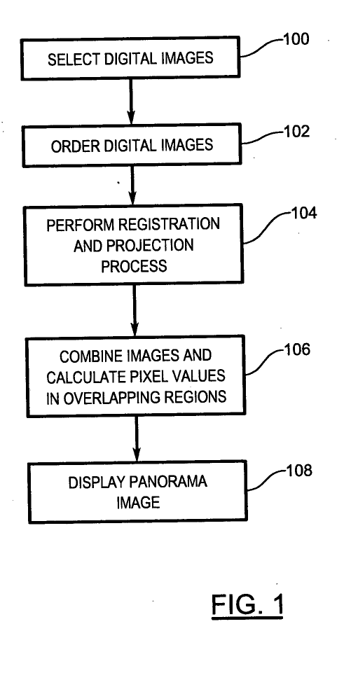

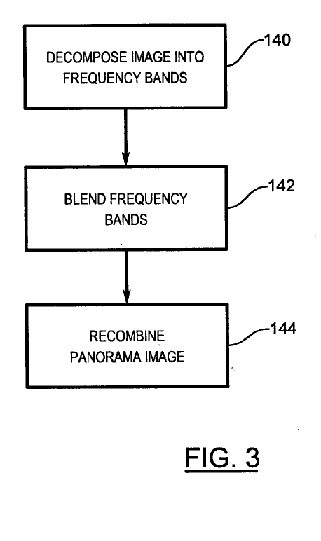

The present invention is preferably embodied in a software application executed by a processing unit such as a personal computer or the like. The software application may run as a stand-alone digital image editing tool or may be incorporated into other available digital image editing applications to provide enhanced functionality to those digital image editing applications. A preferred embodiment of the present invention will now be described more fully with reference to FIGS. 1 to 5.

Turning now to FIG. 1, a flowchart showing a method of creating a panorama image from a series of source images in accordance with the present invention is illustrated. As can be seen, initially a user, through a graphical user interface, selects a series of related overlapping digital images stored in memory such as on the hard drive of a personal computer for display (step 100). Once selected, the user places the series of digital images in the desired left-to-right or right-to-left order so that each pair of adjoining images includes overlapping portions (step 102). Following image ordering, an image registration and projection process is carried out to register adjoining pairs of images in the series and to calculate transforms that detail the transformation between the adjoining pairs of images in the series and enable each image in the series to be projected onto the center image in the series (step 104). Once the image registration and projection process is complete, an image blending process is performed to combine the overlapping images and calculate single pixel values from multiple input pixels in the overlapping image regions (step 106). With image blending completed, a panorama image results that is displayed to the user (step 108).

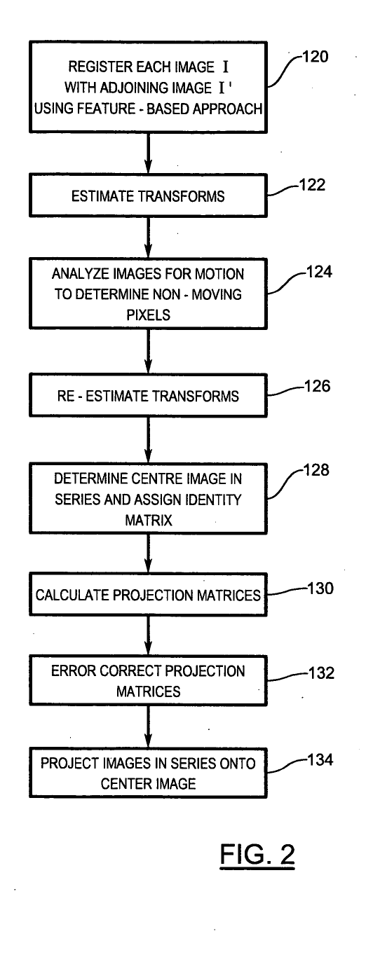

During the image registration and projection process at step 104, starting with the “left-most” image in the series, each image I is registered with the next adjoining image I′ to its right in order using a feature-based registration approach (see step 120 in FIG. 2). During feature-based registration of a pair of adjoining images, features corresponding to high curvature points in the adjoining images I and I′ are extracted and corners within the features are detected. Grey-scale Harris corner detect is adopted and is based on the following operator:

$$c ( x , y ) = \frac{{( {{I}_{x}}^{\overline{\_}} )}^{2} {( {{I}_{y}}^{\overline{\_}} )}^{2} - {( {{I}_{x}}^{\overline{\_}} {{I}_{y}}^{\overline{\_}} )}^{2}}{{( {{I}_{x}}^{\overline{\_}} )}^{2} + {( {{I}_{y}}^{\overline{\_}} )}^{2} + ɛ}$$

where:
c(x, y) is a detected corner;
y and x are the co-ordinates of a pixel in the image assuming the top-left corner of the image is at co-ordinate (0,0);
Iₓ and I_{y} indicate the directional derivatives respectively;
ε is a small number to avoid overflow; and
{double overscore (I)} is a box filter smoothing operation on Iₓ and I_{y}.

A 7×7 pixel window is used to filter out closed corners within a small neighbourhood surrounding each feature. The first three hundred corners c(x, y) detected in each of the adjoining images I and I′ are used. If the number of detected corners in the adjoining images I and I′ is less than three hundred, all of the detected corners are used.

For each corner c in image I, a correlation for all corners c′ in image I′ is made. This is equivalent to searching the entire image I′ for each corner c of image I. A window centered at corner c and c′ is used to determine the correlation between the corners c and c′. Normalized cross correlation NCC is used for calculating a correlation score between corners c(u,v) in image I and corners c′(u′,v′) in image I′. The normalized cross correlation NCC is expressed as:

$$\begin{matrix}NCC ( c , {c}^{′} ) = \\ \frac{{\sum }_{i = - 7}^{7} {\sum }_{j = - 7}^{7} ( I ( u + i , v + j ) - {μ}_{{I}^{′}} )}{{[ {\sum }_{i = - 7}^{7} {\sum }_{j = - 7}^{7} {( I ( u + i , v + j ) - {μ}_{I} )}^{2} {\sum }_{i = - 7}^{7} {\sum }_{j = - 7}^{7} {( {I}^{′} ( {u}^{′} + i , {v}^{′} + j ) {μ}_{{I}^{′}} )}^{2} ]}^{1 / 2}}\end{matrix}$$

The correlation score ranges from minus 1, for two correlation windows that are not similar at all, to 1 for two correlation windows that are identical. A threshold is applied to choose the matching pairs of corners. In the present embodiment, a threshold value equal to 0.6 is used although the threshold value may change for particular applications. After initial corner matching, a list of corners is obtained in which each corner c in image I has set of candidate matching corners c′ in image I′. In the preferred embodiment, the maximum permissible number of candidate matching corners is set to 20, so that each corner c in image I possibly has 0 to 20 candidate matching corners in image I′.

Once each corner c in image I has been matched to a set of candidate matching corners in image I′, a relaxation technique is used to disambiguate the matching corners. For the purposes of relaxation it is assumed that a candidate matching corner pair (c, c′) exists where c is a corner in image I and c′ is a corner in image I′. Let Ψ(c) and T(c′) be the neighbour corners of corners c and c′ within a neighbourhood of N×M pixels. If candidate matching corner pair (c, c′) is a good match, many other matching corner pairs (g, g′) will be seen within the neighbourhood where g is a corner of Ψ(c) and g′ is a corner of T(c′) such that the position of corner g relative to corner c will be similar to that of corner g′ relative to corner c′. On the contrary, if candidate matching corner pair (c, c′) is a bad match, only a few or perhaps no matching corner pairs in the neighbourhood will be seen.

A score of matching SM is used to measure the likelihood that candidate matching corners c and c′ are in fact the same corners according to:

$$SM ( c , {c}^{′} ) = {\sum }_{{g}_{i} ∈ Ψ ( c )} [ {Max}_{{g}_{j}^{′} ∈ Ψ ( {c}^{′} )} \frac{NCC ( {g}_{i} {g}_{j}^{′} ) δ ( c , {c}^{′} ; {g}_{i} {g}_{j}^{′} )}{K + dist ( c , {c}^{′} ; {g}_{i} , {g}_{j}^{′} )} ]$$

where:
NCC(g, g′) is the correlation score described above;
K=5.0 is a constant weight;
dist(c, c′; gᵢ,g′ⱼ)=└d(c,gᵢ)+d(c′,g′ⱼ)┘/2, with d(c,gᵢ) being the Euclidean distance between corners c and gᵢ and d(c′,g′ⱼ) being the Euclidean distance betweeen corners c′ and g′ⱼ; and

$$\begin{matrix}δ ( c , {c}^{′} ; g , {g}^{′} ) = \{ \begin{matrix}{ⅇ}^{- r / λ} & if ( g , {g}^{′} ) is a candidate match and r < λ \\ 0 & otherwise\end{matrix} \\ in which , \\ r = \frac{\vert d ( {c}_{i} , {g}_{i} ) - d ( {c}^{′} , {g}_{j}^{′} ) \vert}{dist ( c , {c}^{′} ; {g}_{i} , {g}_{j}^{′} )} ; and \\ λ = 0.3 is a threshold based on the relative distance difference .\end{matrix}$$

It is assumed that the angle of rotation in the image plane is less than 60 degrees. The angle between vectors 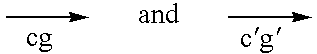
is checked to determine if it is larger than 60 degrees and if so, δ(c, c′; g, g′) takes the value of 0. The candidate matching corner c′ in the set that yields the maximum score of matching SM is selected as the matching corner.

Following performance of the above relaxation technique, a list of matching corners exists without ambiguity such that a corner c of image I only corresponds to one corner c′ in image I′ thereby to yield a registration matrix for each image I that registers the corners c in image I to corresponding corners c′ in adjoining image I′.

With the corners c and c′ in the adjoining images I and I′ registered, a transform based on the list of matching corners for each pair of adjoining images is estimated (step 122). Since there may be a large number of false corner matches, especially if the two adjoining images I and I′ have small overlapping parts, a robust transform estimating technique is used.

In the preferred embodiment, a projective transform estimating routine is selected by default to estimate the transform detailing the transformation between each pair of adjoining images. Alternatively, the user can select either an affine transform estimating routine or a translation estimating routine to estimate the transform if the user believes only non-projective motion in the series of images exists. As will be appreciated, estimating an affine transform or a translation is easier and thus faster than estimating a projective transform.

During execution of the projective transform estimating routine, a random sample consensus algorithm (RANSAC) based technique is used. Initially, N pairs of matching corners are chosen from the registration matrix and a projective transform detailing the transformation between the matching corners is estimated by solving a set of linear equations modelling the projective transform. The estimated projective transform is then evaluated by examining the support from other pairs of matching corners. This process is performed using other sets of randomly chosen N pairs of matching corners. The projective transform that supports the maximum number of corner matches is selected. In particular, the above-described process is carried out following the procedure below:

1. MaxN [symbol] 0
2. Iteration [symbol] 1
3. For each set of randomly chosen N pairs of matching corners,
perform steps 4 to 10
4. Iteration [symbol] Iteration+1
5. If (Iteration>MaxIteration), go to step 11.
6. Estimate the projective transform by solving the appropriate set
of linear equations
7. Calculate N, the number of matched corner pairs supporting the
projective tranform
8. If (N>MaxN), perform steps 9 and 10; else go to step 3
9. MaxN [symbol] N
10. Optimal Transform [symbol] Current Transform
11. if (MaxN>5), return success; otherwise return failure.

Theoretically, to estimate the projective transform, four pairs of matching corners are needed. It is possible that a pair of matching corners is dependent, which makes the matrix singular. To avoid this, at least five pairs of matching corners are required for a successful projective transform estimation to be determined. A least squares LSQR solver is used to solve the set of linear equations and a heuristic constraint is applied. That is, if the estimated projective transform matrix is not satisfied by the heuristic constraint, then it is assumed the projective transform estimation is bad and there should be no matching corners supporting it. For transform matrix M having the form:

$$M = [ \begin{matrix}{a}_{11} & {a}_{12} & {a}_{13} \\ {a}_{21} & {a}_{12} & {a}_{23} \\ {a}_{31} & {a}_{12} & 1.0\end{matrix} ] ,$$

Then M should satisfy the following constraint:
|a₁₁|∈(0.5,1.7),|a₁₂|<0.8,|a₁₃|<W,
|a₂₁|<0.8,|a₁₂|∈(0.5,1.7),|a₂₃|<H,
|a₃₁|<0.1,|a₂₃|<0.1.
in which, W and H are the width and height of the image, respectively.

The maximum number of iterations (MaxIteration) is given heuristically too. In the preferred embodiment, the maximum number of iterations follows the equation:
P=1−[1−(1−χ)^{η}]^{m},
where:
P is the probability to ensure there is a correct solution;
χ is the percentage of false matching corner pairs;
η is the number of matching corners needed for a solution (eight for affine and ten for projective); and
m is the maximum number of random iterations.

To speed up the approach, a two-step estimation is used. Initially, a maximum number of 250 iterations for projective transform estimation is performed. If the estimation fails, 2000 iterations are performed for projective transform estimation. If the estimation process still does not succeed, the translation estimating routine is executed in an attempt to approximate a translation as will be described.

If the user selects the affine transform estimating routine the above-described procedure is performed using the appropriate set of linear equations that model the affine transform. Theoretically to estimate the affine transform three pairs of matching corners are needed. To avoid the situation where a pair of matching corners is dependent resulting in a singular matrix, in the present embodiment at least four pairs of matching corners are required for a successful affine transform estimation to be determined. During the two-step estimation approach, a maximum number of 100 iterations is initially performed. If the estimation fails, 1000 iterations are performed. If the estimation process still does not succeed, the translation estimation routine is executed.

As mentioned above, if the projective or affine transform estimation fails or if the user selects the translation estimating routine, a translation estimation is performed. During execution of the translation estimating routine, it is necessary to determine two parameters dx and dy which only need one pair of matching corners. Considering that there may be many false corner matches, the following routine is performed to determine the translation:

1. MaxN [symbol] 0
2. For each pair of matched corners, perform steps 2 to 7
3. Calculate translation between matched corners
4. Calculate N, the number of matched corner pairs supporting
the translation
5. If (N>MaxN), perform steps 5 to 7; else go to step 2
6. MaxN [symbol] N
7. Optimal Translation [symbol] Current Translation
8. if (MaxN>3), return success; otherwise return failure.

The above procedure estimates the translation supported by the maximum number of matched corner pairs. A matched corner pair supports the translation if and only if the translated corner in image I′ falls within a 3×3 pixel neighbourhood of its corresponding corner in the image I.

After the transform between each adjoining pair of images I and I′ has been determined resulting in transformation matrices that project each image I onto its adjoining image I′, the adjoining pairs of images are analyzed for motion (step 124). During this process, a mask that describes moving objects between adjoining images is generated to avoid object doubling in the panorama image. Pixels in aligned images will generally be very similar except for small differences in lighting. A difference image is generated for each pair of adjoining images and a threshold is applied to determine pixels in the adjoining images that moved. Black pixels in the difference image represent pixels that do not move and white pixels in the difference image represent pixels that move. The transform between each adjoining image is then re-estimated excluding pixels in the adjoining images that move (step 126).

Following determination of the registration and transformation matrices, the center image in the series of images is determined and is assigned an identity matrix (step 128). Specifically, the center image is determined to be the image in the int(N/2) position in the series. A projection matrix is then determined for each image I in the series that projects the image I onto the center image (step 130) by calculating the product of the registration matrix associated with image I and the series of transformation matrices associated with images between the image I and the center image. The resulting projection matrices project the images I in the series onto the plane of the center image. During this process, error accumulates through each transformation or matrix product. Comparing corner to corner to corner matching through successive adjoining images using the registration matrices associated with the adjoining images with the results of the mathematical matrix calculations allows the error to be determined. Thus, the registration matrices are used to modify the resulting projection matrices that project the images onto the center image to take into account the error (step 132). The error corrected projection matrices are then used to project the images in the series onto the plane of the center image in a generally error free manner resulting in an overlapping series of registered images (step 134).

During image blending at step 106, when the sections of the images that overlap are being combined, single output pixel values are calculated from multiple input pixels. This is achieved by frequency blending the overlapping regions of the registered images.

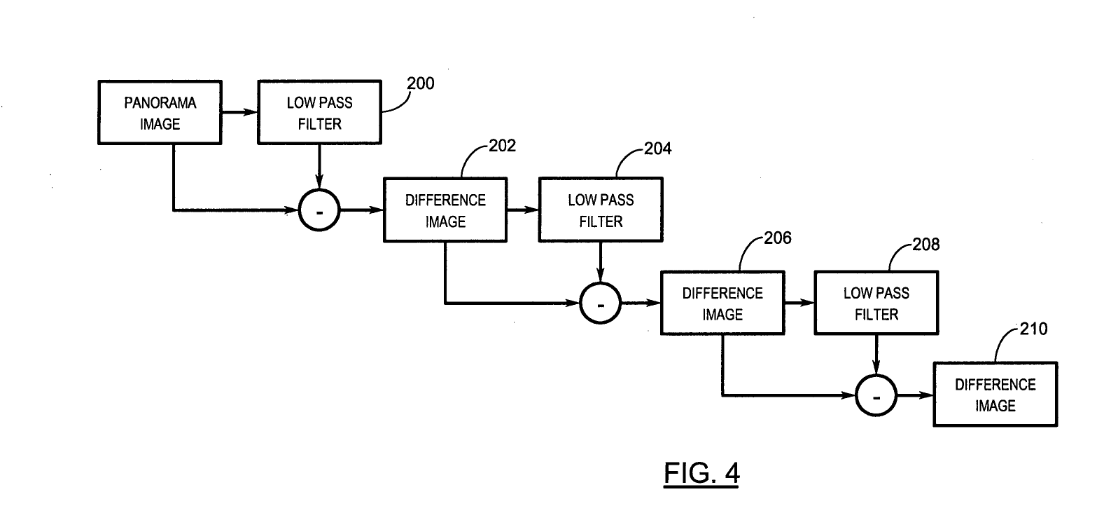

The frequency blending allows areas of larger colour to be blended smoothly and to avoid smooth blending in detail areas. To achieve this, the combined images are decomposed into a number of different frequency bands (step 140) and a narrow area of blending for each frequency band is performed as shown in FIG. 4. The blended bands are then summed to yield the resulting panorama image. Specifically, the combined images are passed through a low pass filter 200 to yield filtered images with the high frequency content removed. The filtered images are then subtracted from the original images to yield difference images 202 including high frequency content representing rapidly changing detail areas in the overlapping regions. The difference images are then passed through another different low pass filter 204 to yield filtered images. The filtered images are subtracted from the difference images 202 to yield difference images 206. This process is repeated once more using yet another different low pass filter 208 resulting in three sets of difference images 203, 206 and 210, each set including a different frequency content. Linear transforms are applied to the resulting difference images to perform the blending in the frequency bands (step 142) and the blended difference images are recombined to recreate the final panorama image (step 144).

Each linear transform is a linear combination of the currently considered image and the current output image. During the linear transformation, the longest line that bisects the overlapping region of the current image and the most recently composited image is found. For each pixel in the overlapping region, the perpendicular distance from that line is found and stored in a buffer. During the blending phase, the contents of the buffer are used to calculate a weight with which to blend the current image with the output image. Pixels from the current image I are blended with the output image O using a standard linear blending equation of the form:
O=weight*I+(1−weight)*O
The value of weight is calculated using an exponential ramp function that approaches zero at the outer edge of the current image, and approaches one at the outer edge of the most recently composited image. The following equation is used to calculate the value weight:

$$weight = \frac{1}{1 + exp ( d * {p}_{n} )}$$

where:
d is the distance from the longest line referenced above; and
pₙ is a parameter that controls the blending function for frequency level n.

A larger value of pₙ for level n results in a steeper curve and thus, a narrower blending area for that level. Conversely, smaller values of pₙ result in a shallower curve and thus, a wider blending area. This allows each frequency band of the images to be blended together with differing weighting functions. In the preferred embodiment, shallow curves are used for the lower frequency bands giving gradual changes in intensity for images that have different exposure levels. Steeper curves are used for higher frequency bands, thus avoiding ghosting that would occur if the input images were not perfectly aligned.

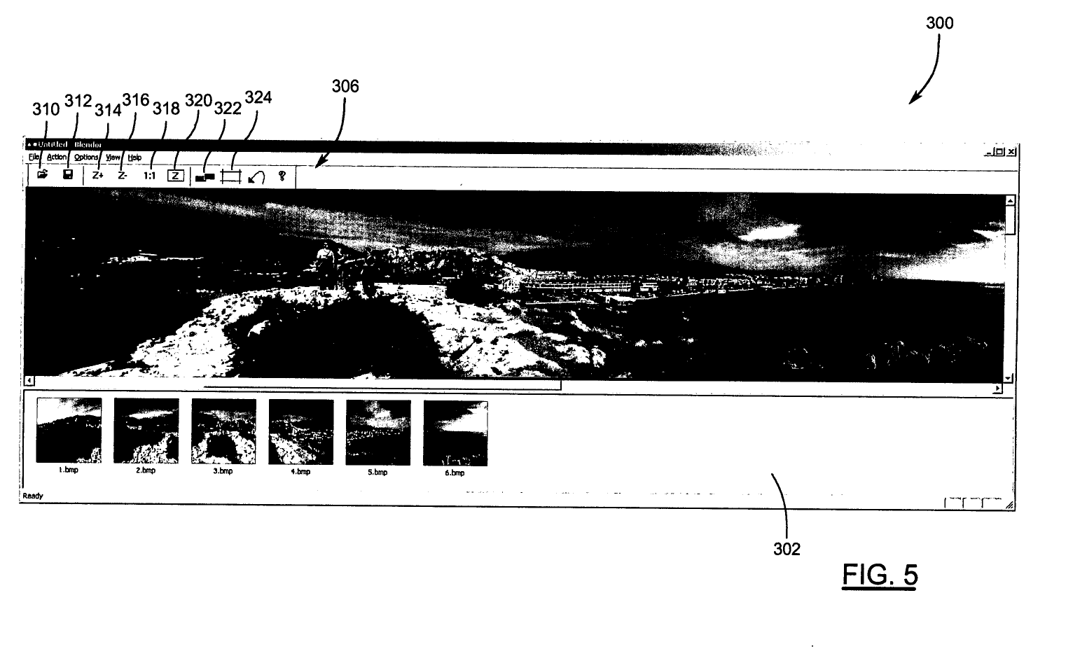

FIG. 5 is a screen shot showing the graphical user interface of the digital image editing tool. As can be seen, the graphical user interface 300 includes a palette 302 in which the digital source images to be combined to form a panorama image are presented. The resulting panorama image is also presented in the palette 302 above the series of digital images. A tool bar 306 extends along the top of the palette 302 and includes a number of user selectable buttons. Specifically, the tool bar 306 includes an open digital file button 310, a save digital image button 312, a zoom-in button 314, a zoom-out button 316, a one to one button 318, a fit-to-pallet button 320, a perform image combining button 322 and a cropping button 324. Selecting the zoom-in button 314 enlarges the panorama image presented in the palette 302. Selecting the zoom-out button 316 shrinks the panorama image presented in the palette 302. Selecting the fit-to-palette 320 fits the entire panorama image to the size of the palette 302. Selecting the cropping button 324 allows the user to delineate a portion of the panorama image presented in the palette 302 with a rectangle and delete the portion of the image outside of the rectangle.

As will be appreciated, the present system and method allows a panorama image to be created from a series of source images in a fast and efficient manner while maintaining high image quality.

The present invention can be embodied as computer readable program code stored on a computer readable medium. The computer readable medium is any data storage device that can store data, which can thereafter be read by a computer system. Examples of computer readable medium include read-only memory, random-access memory, CD-ROMs, magnetic tape and optical data storage devices. The computer readable program code can also be distributed over a network including coupled computer systems so that the computer readable program code is stored and executed in a distributed fashion.

Although a preferred embodiment of the present invention has been described, those of skill in the art will appreciate that variations and modifications may be made without departing from the spirit and scope thereof as defined by the appended claims.

1. A method of creating a panorama image from a series of source images comprising the steps of:
registering adjoining pairs of images in said series based on common features within said adjoining pairs of images;
estimating a transform between each adjoining pair of images using said common features;
projecting each image onto a designated image in said series using the estimated transforms associated with said image and with images between said each image and said designated image; and
combining overlapping portions of the projected images to form said panorama image.

2. The method of claim 1 wherein during said registering, matching corners in adjoining images are determined.

3. The method of claim 2 wherein said transform is a projective transform.

4. The method of claim 2 wherein after said estimating said transform is re-estimated using pixels in said adjoining pairs of images that do not move prior to said projecting.

5. The method of claim 1 wherein during said combining, overlapping portions of said projected images are frequency blended.

6. The method of claim 4 wherein said matching corner registration is used to error correct said projecting.

7. The method of claim 6 wherein during said combining, overlapping portions of said projected images are frequency blended.

8. The method of claim 7 wherein during said estimating, one of a projective, affine and translation transform is estimated.

9. The method of claim 1 wherein registering each pair of adjoining images I and I′ includes the steps of:
extracting features in each of said images I and I′ corresponding to high curvature points therein;
determining corners adjacent said features; and
matching the corners of image I to corresponding corners of image I′ thereby to register said images I and I′.

10. The method of claim 9 wherein during said determining, corners within a neighbourhood surrounding said features are detected.

11. The method of claim 10 wherein said determining is performed until a threshold number of corners is detected.

12. The method of claim 11 wherein during said matching, each detected corner in image I′ is compared with each detected corner in image I to determine matching corners in said images I and I′.

13. The method of claim 12 wherein said comparing includes the steps of:
determining the correlation between each detected corner in image I′ with each detected corner in image I to yield a list of corners in which each corner in image I has a set of candidate matching corners in image I′;
measuring the likelihood that each of the candidate matching corners in said set corresponds to the associated corner in image I; and
selecting one of the candidate matching corners in said set.

14. The method of claim 13 wherein during said correlation determining, a normalized cross correlation is used to calculate a correlation score between each detected corner in image I′ with each detected corner in image I, correlation scores above a threshold level signifying a candidate matching corner.

15. The method of claim 14 wherein said correlation determining is performed until a threshold number of candidate matching corners is determined thereby to form said set.

16. The method of claim 15 wherein during said measuring, a score of matching is used to measure the likelihood that each of the candidate matching corners in said set corresponds to the associated corner in image I based on other matching corner pairs within a neighbourhood surrounding the corners being matched.

17. The method of claim 9 wherein said estimating includes the steps of:
selected N pairs of matching corners; and
solving a set of linear equations modelling said transform thereby to estimate a transform detailing the transformation between said matching corners.

18. The method of claim 17 wherein said estimating further includes the steps of:
applying the estimated transform to non-selected pairs of matching corners to evaluate the accuracy of said transform; and
repeating said selecting, solving and applying iterations to determine the most accurate transform.

19. The method of claim 18 wherein during said estimating, one of a projective, affine and translation transform is estimated.

20. The method of claim 19 wherein said transform being estimated is a projective transform, if said estimating fails to yield a projective transform having an accuracy above a threshold, said estimating is re-performed to determine a translation.

21. The method of claim 19 wherein said transform being estimated is a affine transform, if said estimating fails to yield a projective transform having an accuracy above a threshold, said estimating is re-performed to determine a translation.

22. The method of claim 17 wherein following said estimating of the transform for each adjoining pair of images, the transforms are re-estimated using only pixels in the adjoining pairs of images that do not move.

23. The method of claim 22 wherein during the projecting, each image is projected onto the designated image using a projection matrix derived from the product of the transforms associated with said each image and with images between said each image and said designated image, said projection matrix being error corrected using said matching corner registrations.

24. The method of claim 23 wherein during said combining, overlapping portions of said images are frequency blended.

25. The method of claim 24 wherein during said frequency blending, different frequency content of said overlapping portions are blended with differing weighting functions.

26. A method of creating a panorama image from a series of source images comprising the steps of:
registering corners in each adjoining pair of images in said series;
using the registered corners to estimate transforms detailing the transformation between each adjoining pair of images;
re-estimating the transforms using non-moving pixels in the adjoining pairs of images;
multiplying series of transforms to project each image onto the center image of said series and error correcting the projections using the registered corners; and
frequency blending the overlapping regions of said projected images to yield said panorama image.

27. The method of claim 26 wherein during said frequency blending, different frequency content of said overlapping regions are blended with differing weighting functions.

28. The method of claim 26 wherein during said estimating and re-estimating, projective transforms are estimated.

29. The method of claim 28 wherein during said estimating if projective transforms having an accuracy above a threshold cannot be determined, translations are estimated and re-estimated.

30. The method of claim 26 wherein during said estimating and re-estimating, affine transforms are estimated.

31. The method of claim 30 wherein during said estimating if projective transforms having an accuracy above a threshold cannot be determined, translations are estimated and re-estimated.

32. A digital image editing tool for creating a panorama image from a series of source images comprising:
means for registering adjoining pairs of images in said series based on common features within said adjoining pairs of images;
means for estimating transforms between adjoining pairs of images using said common features;
means for projecting each image onto a designated image in said series using the estimated transforms associated with said image and with images between said each image and said designated image; and
means for combining overlapping portions of the projected images to form said panorama image.

33. A digital imaging editing tool according to claim 32 wherein said means for registering matches corners in adjoining pairs of images.

34. A digital image editing tool according to claim 33 wherein said means for estimating re-estimates each transform using pixels in said adjoining pairs of images that do not move.

35. A digital image editing tool according to claim 34 wherein said means for combining frequency blends overlapping portions of said projected images.

36. A digital image editing tool according to claim 35 wherein said means for estimating estimates one of a projective, affine and translation transform.

37. A computer readable medium embodying a computer program for creating a panorama image from a series of source images, said computer program including:
computer program code for registering adjoining pairs of images in said series based on common features within said adjoining pairs of images;
computer program code for estimating a transform between each adjoining pair of images using said common features;
computer program code for projecting each image onto a designated image in said series using the estimated transforms associated with said image and with images between said each image and said designated image; and
computer program code for combining overlapping portions of the projected images to form said panorama image.

38. A computer readable medium embodying a computer program for creating a panorama image from a series of source images, said computer program including:
computer program code for registering corners in each adjoining pair of images in said series;
computer program code for using the registered corners to estimate transforms detailing the transformation between each adjoining pair of images;
computer program code for re-estimating the transforms using nonmoving pixels in the adjoining pairs of images;
computer program code for multiplying series of transforms to project each image onto the center image of said series and error correcting the projections using the registered corners; and
computer program code for frequency blending the overlapping regions of said projected images to yield said panorama image.
